(19) United States
(12) Patent Application Publication
(10) Pub. No.: US 2025/0289519 A1
(43) Pub. Date: Sep. 18, 2025

(54) All-terrain utility vehicle track mounting bracket system

(71) Applicant: Jesse Tilton, Otis Orchards, WA (US)

(72) Inventor: Jesse Tilton, Otis Orchards, WA (US)

(21) Appl. No.: 18/541,661

(22) Filed: Dec. 15, 2023

(51) Int. Cl. B62D 55/32

(52) U.S. Cl. CPC B62D 55/32

(57) ABSTRACT

An apparatus is described including a track system having a track configured to rotate on rollers and a knuckle bracket coupled to the track system and configured to mount to caliper bolt holes that support mounting of ground engaging wheels of a vehicle.

### BACKGROUND OF INVENTION

The present invention relates to a front and rear assembly system to mount tracks to all-terrain utility vehicles. The assembly includes a bracket arrangement that secures an endless track system to the front and rear of the vehicle.

All-terrain utility vehicles, or UTV's, are versatile all-season motorized vehicles designed for off road use in a variety of terrain and conditions including steep, soft, slippery, or irregular grounds including soil, sand, mud, rocks, snow, ice etc. The term “all-terrain vehicle” or “UTV” includes within its scope any and all “side-by-side” utility or recreational vehicles including but not exclusive to Polaris Turbo S, Can-Am X3, Kawasaki TXR, Yamaha RMAXX 1000, etc.

These UTV's used for recreational, utility, and/or other purposes are sometimes provided with track assemblies having endless tracks which engage the ground for traction. The track assemblies are mounted in place of ground-engaging wheels which would otherwise be used for traction in order to enhance the UTV's floatation and traction on the ground—namely in winter snow conditions.

Traditionally, these endless track assemblies are fastened to the UTV's front anti-rotation arms and front steering limiter strap and the UTV's rear trailing arm and rear mudscraper. While various designs of brackets and mounting hardware have been developed to secure an endless track system to UTV's in this way, they suffer from some drawbacks.

For example:
Existing UTV track mounting assemblies may not be compatible with aftermarket suspension configurations-thus hindering the ability to install or use tracks on UTVs with aftermarket parts.
Existing UTV track mounting assemblies may not be optimal for high-speed riding on trails or for riding in other situations or environments due to the fact that the dynamics of a UTV may change significantly because of the track assemblies' additional weight and configuration which are different from that of ground-engaging wheels with which the UTV may have been designed to be equipped.
Existing UTV track mounting systems may not be designed to be mounted flush against existing components of UTV machine, therefore reducing the machine and track systems capabilities in achieving clearance over various terrain and obstacles (such as deep snow, branches, logs, rocks, etc.).
Existing UTV track mounting assemblies may not be designed to work in optimal conjunction with the mechanical dynamics of the UTV, thereby potentially causing local deformation or damage and may detrimentally impact performance and/or integrity of the UTV machine.
Existing UTV track mounting assemblies may not be optimally designed to fit with the existing dynamics of the UTV machine and require complex installment that requires modification of one or more existing parts of the UTV machine, therefore compromising the integrity of the UTV and resulting in cumbersome and time-consuming installment and application to affix track mounting system and tracks to UTV.
Existing UTV track mounting assemblies may not be capable of working in conjunction with the hardware and mounting assemblies needed to mount ground engaging wheels, thus requiring the user to implement additional steps during installation and removal. There thus remains a need to improve the performance of track assembly mounting systems for all-terrain utility vehicles.

### SUMMARY OF INVENTION

The problems encountered with existing UTV track mounting assemblies have been overcome by the present invention which provides an assembly to affix an endless track system to UTV machines. Although others have invented brackets and other track mounting arrangements to secure endless track systems to UTVs, various aspects of this present invention and newly designed track mounting system are superior because:
The present invention is designed to allow increased articulation of the endless track system while providing balance and structure to adequately support the changes in weight and configuration of UTV machine with tracks, thus providing enhanced versatility and safety across various terrain.
The present invention is designed to mount flush against existing components of UTV machine, therefore increasing the machine and track systems capabilities in achieving a higher level of clearance over various terrain and obstacles (such as deep snow, branches, logs, rocks, etc.).
The present invention is designed to work in conjunction with the mechanical dynamics of the UTV and endless track system movement and articulation, therefore reducing the potential likelihood of damage or harm to UTV, track system, or user during track operations while also enhancing overall performance of UTV and track system.
The present invention is designed to be mounted in conjunction with the existing structures and dynamics of UTV machine, minimizing the need for modification of UTV machine during installment of UTV track mounting system-thus preserving the integrity of the UTV machine and reducing the time and labor needed to properly affix track mounting system to UTV.
The present invention is compatible with aftermarket suspension configurations, allowing track mounting system to be installed on a wider variety of machines regardless of whether or not aftermarket parts have been installed.

### A BRIEF DESCRIPTION OF THE DRAWINGS

FIG. 1 is a birds-eye perspective of the knuckle bracket designed to mount the track system to the front spindle of UTV utilizing caliper bolt holes.
FIG. 2 is a birds-eye perspective of the rear knuckle bracket designed to mount the track system to the rear spindle of the UTV utilizing caliper bolt holes.

The above mentioned features of this invention will become more apparent and the invention itself will be better understood through the following description of embodiments.

### DETAILED DESCRIPTION OF EMBODIMENTS

As required, detailed embodiments of the present invention are disclosed herein; however, it is to be understood that the disclosed embodiments are not intended to be exhaustive or to limit the invention to the precise forms disclosed in the following detailed description. Rather, specific structural and functional details are merely a representative basis for teaching one skilled in the art to employ the present invention in virtually any appropriately detailed structure. Front:

FIG. 1 depicts a bird's-eye perspective of the front knuckle bracket designed to mount the track system to the front knuckle/spindle of UTV utilizing caliper bolt holes. Once the metal is cut into its shape, bolt holes indicated by 10a and 10b are used to secure bracket to the front left and right knuckle of the UTV machine using appropriate bolts and hardware. Endless track systems front left and right antirotation heim joint is secured to machine utilizing bolt hole indicated by number 12.

Once mounted to the front knuckle, the front heim joint, and front anti-rotation arm, bracket stabilizes and prevents movement in the anti-rotation arm as tracks rotate on their rollers (not pictured). Plates are comprised of solid metal that are mounted flush against the knuckle of the UTV, thus allowing proper clearance to avoid interference with the lower ball joint (not pictured) and existing structures and mechanics of UTV.

### Rear

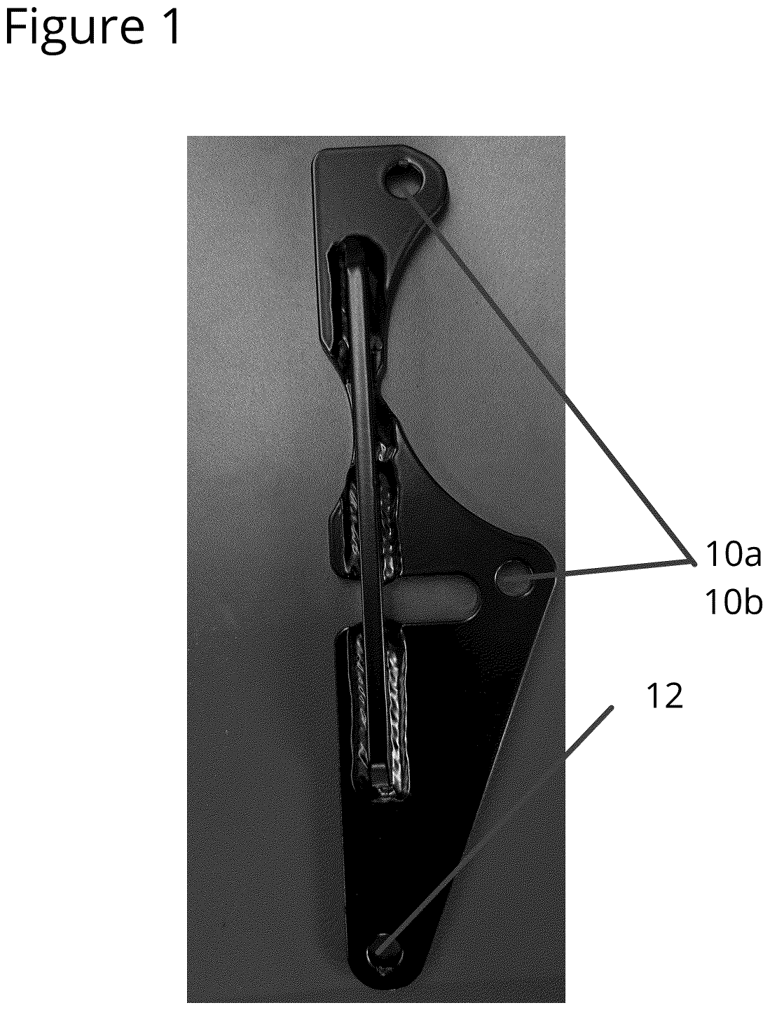

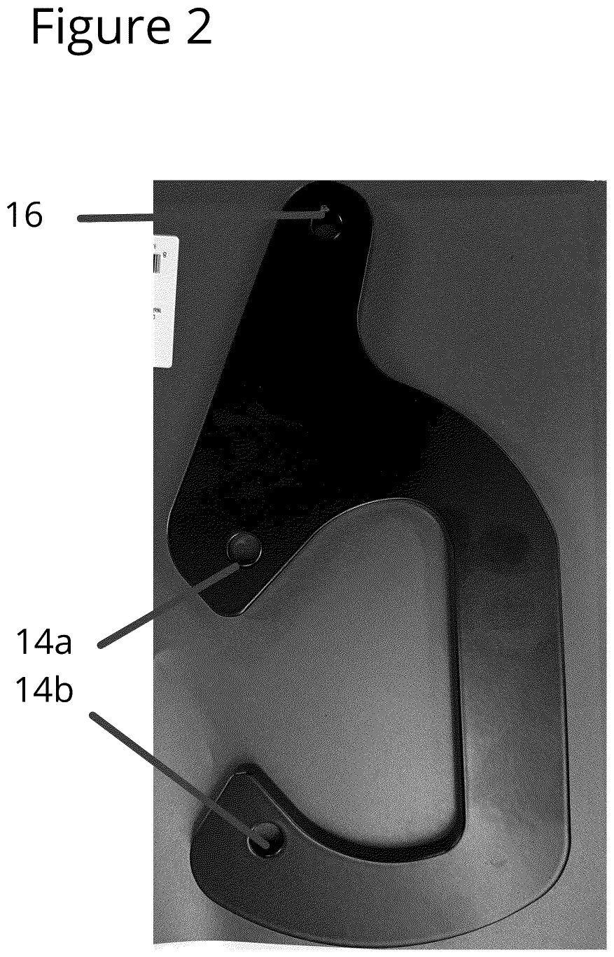

FIG. 2 depicts a birds-eye perspective of the rear knuckle bracket designed to mount the track system to the rear knuckle/spindle of the UTV utilizing caliper bolt holes. Once the metal is cut into its shape, bolt holes indicated by 14a and 14b are used to secure bracket to the rear left and right knuckle of the UTV machine using appropriate bolts and hardware. Endless track systems rear left and right antirotation heim joint is secured to machine utilizing bolt hole indicated by number 16.

Once affixed to the rear knuckle, the rear heim joint, and rear anti-rotation arm, bracket stabilizes and prevents movement in the anti-rotation arm as tracks rotate on their rollers (not pictured). Plates are comprised of solid metal that are mounted flush against the knuckle of the UTV, thus allowing proper clearance to avoid interference with the lower ball joint (not pictured) and existing structures and mechanics of UTV.

Thus it can be seen that this UTV track mounting system will be advantageous in a number of ways including:
Increased safety and reliability
Increased capabilities to traverse rough terrain
Decreased likelihood of damage or harm to UTV unit, tracks, track mounting system, or user
Increased longevity and integrity of UTV machine and tracks due to seamless mounting
Increased versatility in utilizing endless track systems in a wider variety of machines and machines employing aftermarket configurations

### Potential Alternative Embodiments

Considering that modifications and changes may occur to those skilled in the art, it is not desired to limit the UTV track mounting assembly to the exact construction and operation shown and described. A variety of suitable modifications and equivalents may be resorted to and fall within the scope of the presented UTV track mounting assembly. For example, potential alternative embodiments may encompass:
Plates, alignment tabs, and bolt holes could alternatively have other shapes or measurements.
Tabs may be bent to alternative angles.
Material of plates and other hardware may be comprised of any material with suitable strength and similar properties.
Plates may be secured to machine with various fasteners (bolts, cable, screws, etc.).
Bolt holes and alignment tabs may be configured in various sizes, placements, measurements, and spacing.

Although various embodiments and examples have been presented, this was for the purpose of describing, but not limiting, the invention.

What is claimed is:

1. An apparatus comprising:
a track system having a track configured to rotate on rollers;
a knuckle bracket coupled to the track system and configured to mount to caliper bolt holes that support mounting of ground engaging wheels of a vehicle.

2. The apparatus of claim 1, wherein the knuckle bracket includes a helm joint and anti-rotation arm configured stabilize the track system during movement of the track.

3. The apparatus of claim 1, wherein the knuckle bracket is configured to mount flush with the caliper bolt holes.

4. A system comprising:
a vehicle having caliper bolt holes that support mounting of ground engaging wheels;
a track system having a track configured to rotate on rollers and a knuckle bracket configured to mount to the caliper bolt holes.

5. The system of claim 4, wherein the knuckle bracket includes a helm joint and anti-rotation arm configured stabilize the track system during movement of the track.

6. The system of claim 4, wherein the knuckle bracket is configured to mount flush with the caliper bolt holes.
